(19) United States
(12) Patent Application Publication
(10) Pub. No.: US 2011/0113458 A1
(43) Pub. Date: May 12, 2011

(54) APPARATUS AND METHOD FOR PRODUCT TUTORIALS

(75) Inventors: Linda Roberts, Decatur, GA (US); E-Lee Chang, Mableton, GA (US); Ja-Young Sung, Atlanta, GA (US); Natasha Barrett Schultz, Lawrenceville, GA (US); Robert Arthur King, Roswell, GA (US)

(73) Assignee: AT&T INTELLECTUAL PROPERTY I, L.P., RENO, NV (US)

(21) Appl. No.: 12/614,704

(22) Filed: Nov. 9, 2009

(51) Int. Cl. H04N 7/173

(52) U.S. Cl. 725/110

(57) ABSTRACT

A system that incorporates teachings of the present disclosure may include, for example, a set-top-box (STB) having a controller to present media content supplied by a content provider operating in an interactive television (iTV) network, wherein the media content comprises a tutorial for one of a product and a service, the tutorial comprising steps for utilizing one of the product and the service, access via a graphical user interface (GUI) a client program, wherein the client program presents an overlay that superimposes onto the media content, receive a user-generated comment, wherein the user-generated comment is associated with the media content by the client program, transmit the user-generated comment to a third party for analyzing the user-generated comment and determining parameters for evaluating at least one of the product and service tutorial, wherein replacement media content is generated by the third party based on the determined parameters. Other embodiments are disclosed.

### FIELD OF THE DISCLOSURE

The present disclosure relates generally to product tutorials and more specifically to an apparatus and method for product tutorials.

### BACKGROUND

Product and service tutorials can be used by companies to effectively educate consumers about the products and services that they provide. Specifically, such tutorials often include instructions and information on how to use the product or service and various examples of how to use the product or service. Tutorials can be provided to consumers through traditional brochures, printed media, the Internet, and through other means. The effectiveness of the tutorials for a particular product or service is often critical in properly educating consumers about a company's products and services and achieving desired consumer perceptions. Accordingly, enabling consumers to evaluate a product or service tutorial can aid companies in determining the effectiveness of the tutorial and in determining whether or not the tutorial needs improvement.

### BRIEF DESCRIPTION OF THE DRAWINGS

FIGS. 1-2 depict illustrative embodiments of communication systems that provide media services;

FIG. 3 depicts an illustrative embodiment of a portal interacting with the communication systems of FIGS. 1-2;

FIG. 4 depicts an illustrative embodiment of a communication device utilized in the communication systems of FIGS. 1-2;

FIG. 5 depicts an illustrative embodiment of a system for product tutorials, the system operable in the communications systems of FIGS. 1-2;

FIG. 6 depicts a screenshot illustrating a user entering a comment in response to a product tutorial;

FIG. 7 illustrates a screenshot which displays the comment received by the user of FIG. 6;

FIG. 8 depicts an illustrative embodiment of a method for product tutorials, which is operable in portions of the communication systems of FIGS. 1-2 and 5; and

FIG. 9 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a set-top-box (STB) having a controller to present media content supplied by a content provider operating in an interactive television (iTV) network, wherein the media content comprises a tutorial for one of a product and a service, the tutorial comprising steps for utilizing one of the product and the service, access via a graphical user interface (GUI) a client program, wherein the client program presents an overlay that superimposes onto the media content, receive a user-generated comment, wherein the user-generated comment is associated with the media content by the client program, transmit the user-generated comment to a third party for analyzing the user-generated comment and determining parameters for evaluating at least one of the product and service tutorial, wherein replacement media content is generated by the third party based on the determined parameters.

Another embodiment of the present disclosure can entail a method, including transmitting a client program to a media processor operating in an iTV network, wherein the client program comprises a GUI for presenting an overlay that superimposes onto media content presented at the media processor, and wherein the media content comprises a tutorial for one of a product and a service, receiving a user-generated comment from the media processor via the client program, wherein the user-generated comment is associated with the media content by the client program, analyzing the user-generated comment for evaluating one or more steps of the tutorial for one of the product and the service, determining parameters of the media content based on the user-generated comment, and evaluating the one or more steps of the tutorial based on the determined parameters.

Yet another embodiment of the present disclosure can entail a computer-readable storage medium having computer instructions to transmit a request to a computing device for media content and a first user-generated comment associated with the media content, wherein the media content comprises a tutorial for one of a product and a service, receive the media content and the first user-generated comment from the computing device, present the media content and the first user-generated comment, receive a second-user generated comment, wherein the second user-generated comment is associated with at least one of the media content and the first user-generated comment, and transmit the second user-generated comment to the computing device, wherein parameters for evaluating at least one of the product and service tutorial are determined by the computing device based on at least one of the first and second user-generated comments.

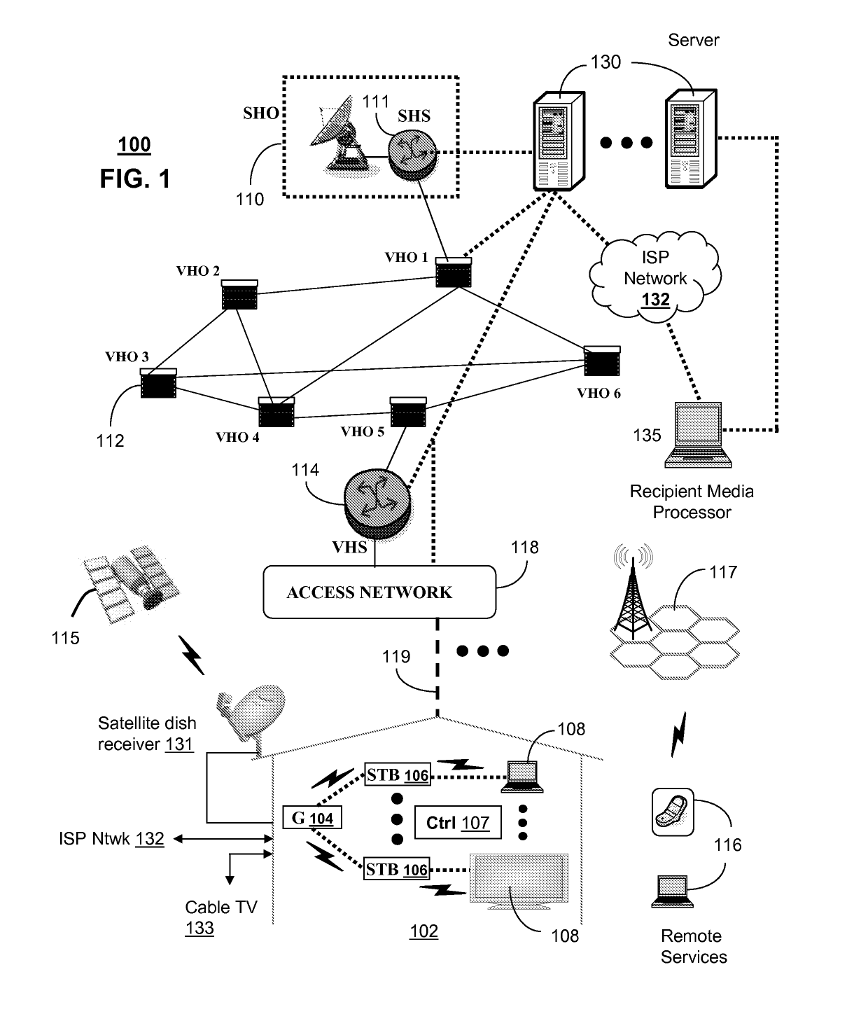

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

The first communication system 100 can also include a recipient media processor 135. The recipient media processor 135 can be configured to operate in an iTV network, which can include, but is not limited to including, IPTV, interactive cable television, and interactive satellite television. Additionally, the recipient media processor 135 can be communicatively linked to the ISP network 132, the one or more computing devices 130, and to other devices in the system 100. Furthermore, the recipient media processor 135 can be a STB, mobile device, personal computer, telephone, personal digital assistant (PDA), or other device capable of requesting, receiving, and transmitting media content.

Operatively, the recipient media processor 135 can be configured to transmit requests for media content and user-generated comments associated with the media content. The media content can be video content, audio content, still image content, text content, and other types of content. The actual media content itself can be product and/or service tutorials that can be used to educated consumers about various products and services provided by companies. The tutorials can comprise one or more steps for utilizing the product and/or service. The transmitted requests can be received and processed by the various devices of the system 100 and can then be transmitted to other devices. Such devices can include, but are not limited to including, the STBs 106, the media devices 108, the computing devices 130, and wireless communications device 116. The media content and user-generated comments can be received by the recipient media processor 135 from the various devices in the system 100 and the recipient media processor 135 can then be configured to present the media content and user-generated comments.

Another distinct portion of the computing devices 130 can function as a server (herein referred to as server 130). The server 130 can use common computing and communication technology to perform the function of receiving and processing media content, user-generated comments, and data. The server 130 can contain or have access to a client program, which can present an overlay that can be superimposed onto media content. The server 130 can enable the devices in the system 100 to access the client program and/or download the client program from the server 130 or otherwise. When a device of the system 100, such as STB 106, presents media content, the device can utilize the client program to superimpose an overlay onto the media content. The overlay can include drop-down menus, buttons, or other operative features that can allow users to provide commentary associated with the presented media content. Additionally, the client program can be configured to receive information associated with the user providing the commentary.

Once the client program has received comments and/or information from users commenting on the presented media content, the client program can transmit the media content, information, and/or comments to the server 130 for processing. The server 130 can proceed to analyze the user-generated comments and information so as to evaluate one or more steps of the tutorial for the product or service. Moreover, the server 130 can then be configured to determine parameters of the media content based on the user-generated comments and/or information. The parameters can include, but are not limited to including, effectiveness parameters, psychographic parameters, and demographic parameters. Based on the various values determined for parameters of the media content and/or the analyzed comments, one or more steps of the tutorial can be altered or replacement content can be generated by the server 130 or other devices in the system 100. The altered and/or replacement content can then be transmitted to a device in the system 100.

Additionally, the server 130 can be configured to receive requests for the media content and the user-generated comments associated with the media content from the devices in the system 100, such as the recipient media processor 135 and the STBs 106. Furthermore, the server 130 can store and/or relay the actual media content and/or the user-generated comments associated with the media content.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

It follows from the above illustrations that the present disclosure can apply to any present or future interactive over-the-air or landline media content services.

FIG. 2 depicts an illustrative embodiment of a communication system 200. employing an IP Multimedia Subsystem (IMS) network architecture to facilitate the combined services of circuit-switched and packet-switched systems. Communication system 200 can be overlaid or operably coupled with communication system 100 as another representative embodiment of communication system 100.

Communication system 200 can comprise a Home Subscriber Server (HSS) 240, a tElephone NUmber Mapping (ENUM) server 230, and other common network elements of an IMS network 250. The IMS network 250 can establish communications between IMS compliant communication devices (CD) 201, 202, Public Switched Telephone Network (PSTN) CDs 203, 205, and combinations thereof by way of a Media Gateway Control Function (MGCF) 220 coupled to a PSTN network 260.

IMS CDs 201, 202 can register with the IMS network 250 by contacting a Proxy Call Session Control Function (P-CSCF) which communicates with a corresponding Serving CSCF (S-CSCF) to register the CDs with at the HSS 240. To initiate a communication session between CDs, an originating IMS CD 201 can submit a Session Initiation Protocol (SIP INVITE) message to an originating P-CSCF 204 which communicates with a corresponding originating S-CSCF 206. The originating S-CSCF 206 can submit queries to the ENUM system 230 to translate an E.164 telephone number in the SIP INVITE to a SIP Uniform Resource Identifier (URI) if the terminating communication device is IMS compliant.

The SIP URI can be used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214. The terminating S-CSCF 214 can then identify a terminating P-CSCF 216 associated with the terminating CD 202. The P-CSCF 216 then signals the CD 202 to establish communications.

If the terminating communication device is instead a PSTN CD such as references 203 or 205, the ENUM system 230 can respond with an unsuccessful address resolution which can cause the originating S-CSCF 206 to forward the call to the MGCF 220 via a Breakout Gateway Control Function (BGCF) 219. The MGCF 220 can then initiate the call to the terminating PSTN CD by common means over the PSTN network 260.

The aforementioned communication process is symmetrical. Accordingly, the terms “originating” and “terminating” in FIG. 2 are interchangeable. It is further noted that communication system 200 can be adapted to support video conferencing by way of common protocols such as H.323. In addition, communication system 200 can be adapted to provide the IMS CDs 201, 203 the multimedia and Internet services of communication system 100.

The server 130 of FIG. 1 can be operably coupled to the second communication system 200 for purposes similar to those described above.

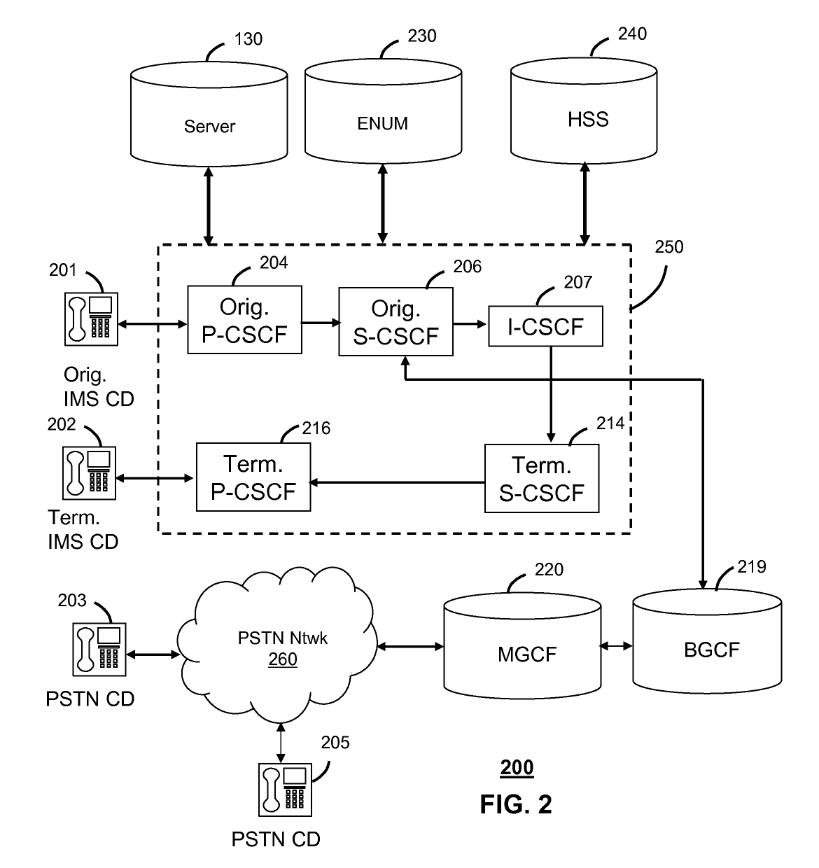

FIG. 3 depicts an illustrative embodiment of a portal 302 which can operate from the computing devices 130 described earlier of communication 100 illustrated in FIG. 1. The portal 302 can be used for managing services of communication systems 100-200. The portal 302 can be accessed by a Uniform Resource Locator (URL) with a common Internet browser such as Microsoft's Internet Explorer™ using an Internet-capable communication device such as those described for FIGS. 1-2. The portal 302 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services described earlier, provisioning Internet services, provisioning cellular phone services, and so on.

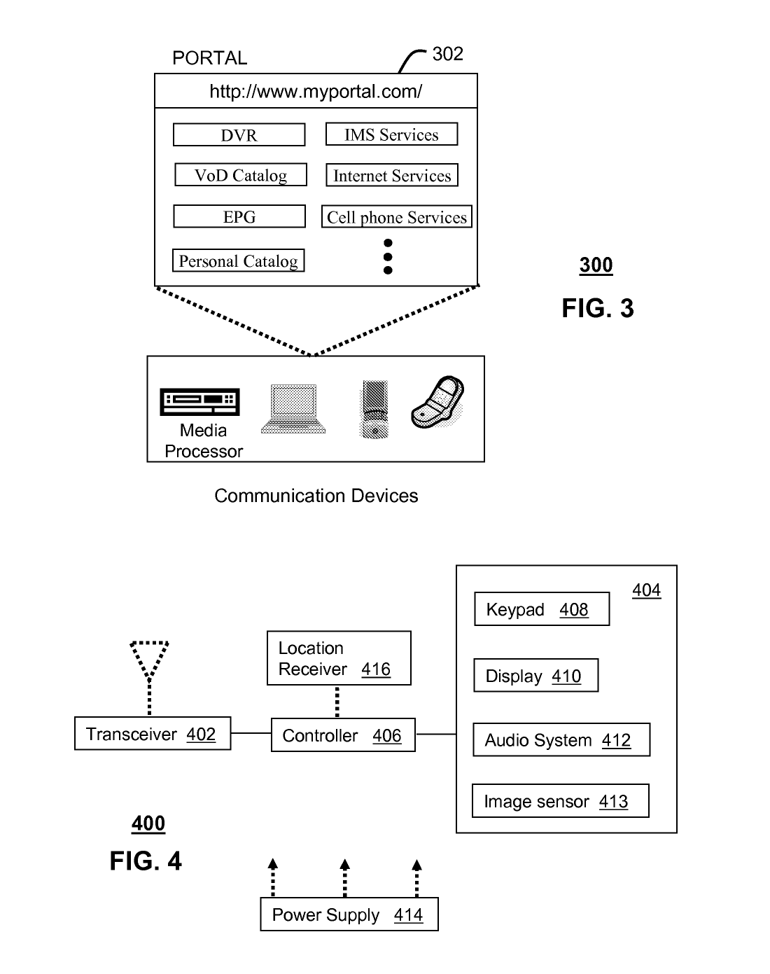

FIG. 4 depicts an exemplary embodiment of a communication device 400. Communication device 400 can serve in whole or in part as an illustrative embodiment of the communication devices of FIGS. 1-2. The communication device 400 can comprise a wireline and/or wireless transceiver 402 (herein transceiver 402), a user interface (UI) 404, a power supply 414, a location receiver 416, and a controller 406 for managing operations thereof. The transceiver 402 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1X, UMTS/HSDPA, GSM/GPRS, TDMA/EDGE, EV/DO, WiMAX, SDR, and next generation cellular wireless communication technologies as they arise. The transceiver 402 can also be adapted to support circuit-switched wireline access technologies (such as PSTN), packet-switched wireline access technologies (such as TCPIP, VoIP, etc.), and combinations thereof.

The UI 404 can include a depressible or touch-sensitive keypad 408 with a navigation mechanism such as a roller ball, joystick, mouse, or navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric dialing keypad commonly used by phones, and/or a Qwerty keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display.

The UI 404 can also include an audio system 412 that utilizes common audio technology for conveying low volume audio (such as audio heard only in the proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and charging system technologies for supplying energy to the components of the communication device 400 to facilitate long-range or short-range portable applications. The location receiver 416 can utilize common location technology such as a global positioning system (GPS) receiver for identifying a location of the communication device 400 based on signals generated by a constellation of GPS satellites, thereby facilitating common location services such as navigation.

The communication device 400 can use the transceiver 402 to also determine a proximity to a cellular, WiFi or Bluetooth access point by common power sensing techniques such as utilizing a received signal strength indicator (RSSI) and/or a signal time of arrival (TOA) or time of flight (TOF). The controller 406 can utilize computing technologies such as a microprocessor, a digital signal processor (DSP), and/or a video processor with associated storage memory such a Flash, ROM, RAM, SRAM, DRAM or other storage technologies.

The communication device 400 can be adapted to perform the functions of the media processor 106, the media devices 108, or the portable communication devices 116 of FIG. 1, as well as the IMS CDs 201-202 and PSTN CDs 203-205 of FIG. 2. It will be appreciated that the communication device 400 can also represent other common devices that can operate in communication systems 100-200 of FIGS. 1-2 such as a gaming console and a media player.

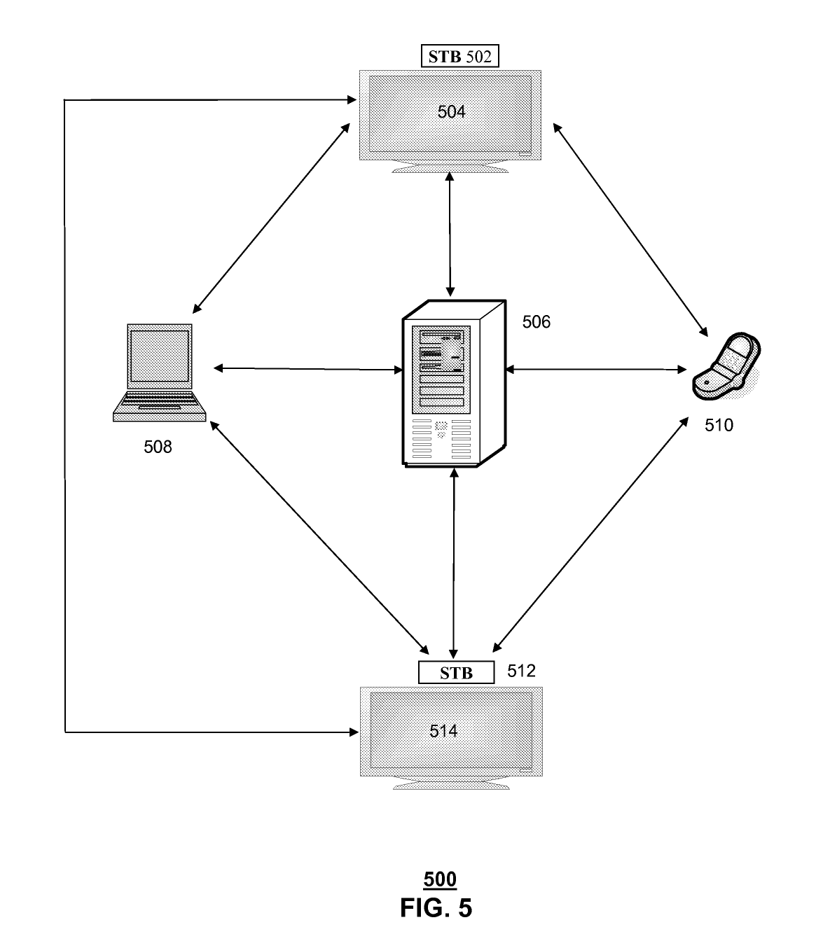

FIG. 5 depicts an illustrative embodiment of a system 500 for product tutorials, the system 500 being operable in portions of the communications systems of FIGS. 1-2. The devices in the system 500 can be configured to operate in an iTV network, which can include IPTV, satellite television, and cable television. Additionally, the devices in the system 500 can be communicatively linked to each other. The system 500 can include a media processor 502, which can be configured to process and deliver media content and other data to display device 504. The media processor 502 can be a STB, personal computer, mobile device, or other similar device. The display device 504 can be a monitor, television, cellular phone, personal digital assistant (PDA), computer, or other device capable of presenting media content. System 500 can also include a server 506, which can contain the operative features of server 130. The media processor 502 and the server 506 can be communicatively linked with the other devices of the system 500.

The server 506 can include a client program or otherwise have access to a client program. The client program can be configured to present an overlay that can be superimposed onto media content that is presented at the devices in the system 500. The overlay can feature drop-down menus, selectable buttons, or other operative features which can allow users to provide commentary associated with the media content that is presented. Additionally, the client program can be configured to receive other information associated with users such as a user name, a location of the user, a user age, a user education level, and other information. The system 500 can further include a computing device 508, a communications device 510, a media processor 512, and a display device 514.

The computing device 508 can be a personal computer, laptop, or other similar device. The communications device 510 can include a mobile device, a cellular phone, a telephone, a wireless device, or other communications device. The media processor 512 can be much like media processor 502 and can be a STB, personal computer, mobile device, or other similar device. The display device 514 can be much like display device 504, which can be a monitor, television, or other display device capable of presenting media content. The server 506 can act as an intermediary between the devices, although the devices in the system 500 can communicate directly with one another. Other arrangements are contemplated.

Operatively, media content can be received at the media processor 502 and can be displayed or otherwise presented by the display device 504. A user of the media processor 502 can view or otherwise experience the media content and can access the client program to provide comments related to the media content or provide other types of comments. The media content can include video content, audio content, still image content, text content, and other content. The actual media content can be a tutorial for a product and/or a service. The tutorial can include a description of the product and/or service and one or more steps for utilizing the product and/or the service. For example, if the product tutorial is for using a telephone, the tutorial can include a description of the telephone along with steps for using the telephone.

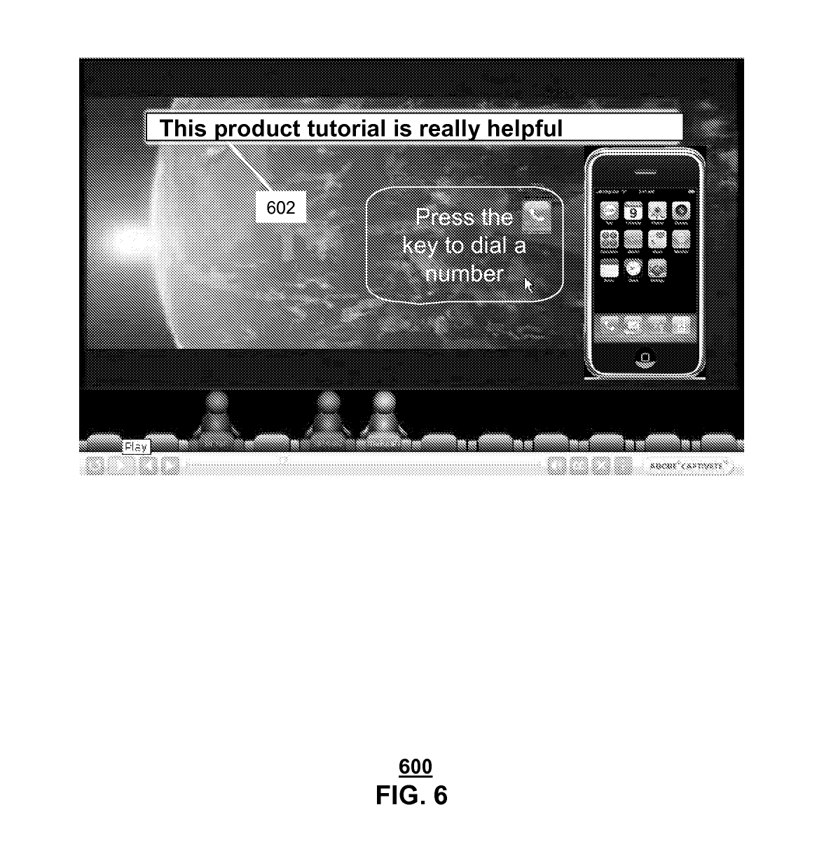

While the user is experiencing the media content or after the user experiences the media content, the user can utilize the client program to input comments, which can be associated with the media content. The comment can be text, audio, or a combination of text and audio. In other words, the user can type in the comment or verbally speak the comment or provide both spoken and text comments. Referring now also to FIG. 6, a screenshot 600 illustrating a user entering a comment in response to a product tutorial is shown. The screenshot 600 depicts a product tutorial for a mobile phone, which shows a user how to utilize the phone and the operative features of the phone. For example, a step in the product tutorial can tell the user to press a particular key on the phone to dial a phone number. At any time during the product tutorial or after the product tutorial, the user can select an option via the client program for entering in a comment.

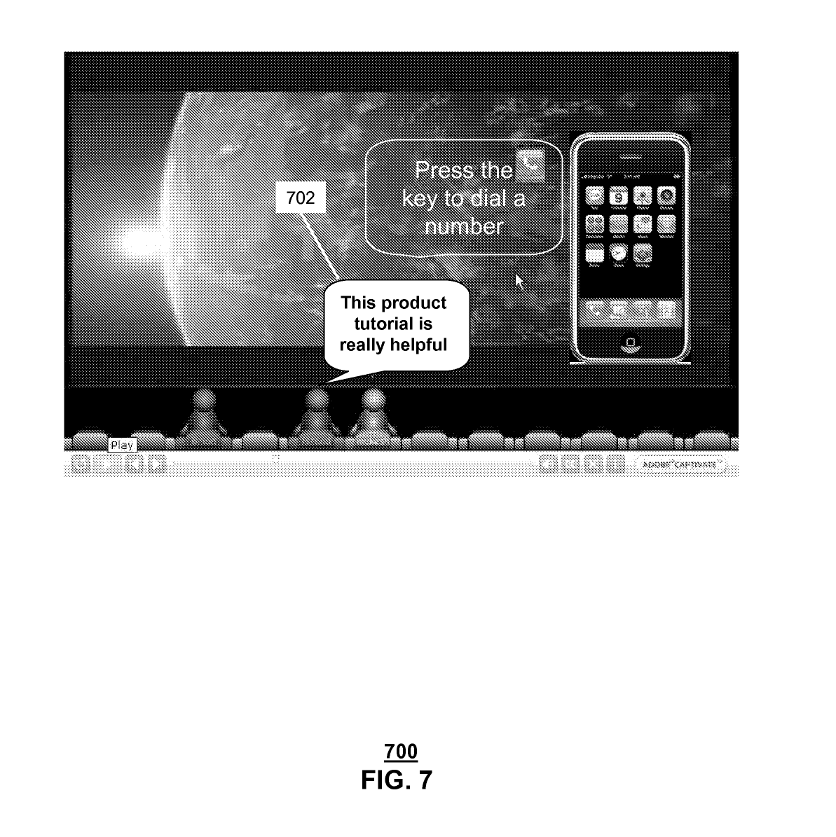

After the user selects the option, a text box 602 can be displayed to the user, which can allow the user to enter in a comment. In this case, the user entered in the comment “This product tutorial is really helpful.” The comment can then be stored by the client program. Referring now also to FIG. 7, a screenshot 700 which displays the comment received by the user of FIG. 6 is illustratively shown. The screenshot 700 shows a caption box 702, which displays the text that the user input into the client program. Once the user-generated comment is received by the client program, the client program can associate the comment with the media content and the media processor 502 can transmit the user-generated comment and/or the media content to the server 506 and or to the other devices of the system 500. As mentioned above, the client program can also receive information associated with the user and can transmit the information to the server 506 and other devices of the system 500.

When the server 506 receives the user-generated comment and/or other information associated with a user, the server 506 can be configured analyze the user-generated comment and/or allow a third party to analyze the user-generated comment. The server 506 and/or the third party can determine parameters for evaluating the product and/or service tutorial. Determination of the parameters can be based on the user-generated comment and/or the other information associated with the user. The parameters can include, but are not limited to including, effectiveness parameters, demographic parameters, and psychographic parameters. The effectiveness parameters can indicate whether a particular product or service tutorial is confusing, ineffective, or successful. The demographic parameters can indicate age, location, gender, race, income, and other attributes of users. Psychographic parameters can be associated with the personality, attitudes, values, lifestyle, and/or interests of the users.

The third party and/or the server 506 can be configured to evaluate the product and/or service tutorial. Notably, the evaluation can be based on the determined parameters and/or the analyzed comments and can be stored by the third party and/or the server 506. Evaluations can be utilized when generating replacement content or altering the media content. Replacement content, for example, can be entirely new product or service tutorials and altered media content can be the original media content featured with modified/adjusted steps. If the evaluations dictate that replacement content or an altered form of the original media content is needed, the content can be generated and transmitted to any of the devices in the system 500. The replacement content and/or the altered media content received by the devices in the system 500 can then be presented at a display device, such as display device 504.

The devices in the system 500 can also be configured to transmit requests for the media content and user-generated comments from the other devices in the system 500. The requests can be received by the server 506, which can then retrieve the comments and/or media content from media processor 502, or the devices can also directly connect to media processor 502 to receive the comments and/or media content. Of course, each device in the system 500 can request comments and media content from the other devices in the system 500. Once the requesting devices receive the comments and/or media content from the media processor 502, users of the requesting devices can provide their own comments about the media content or provide commentary on the other users' comments. Any comments generated by the requesting devices can similarly be transmitted to the server 506 or other devices of the system 500. The server 506 can determine parameters based on the comments coming from the requesting devices and can evaluate the media content based on the comments and determined parameters.

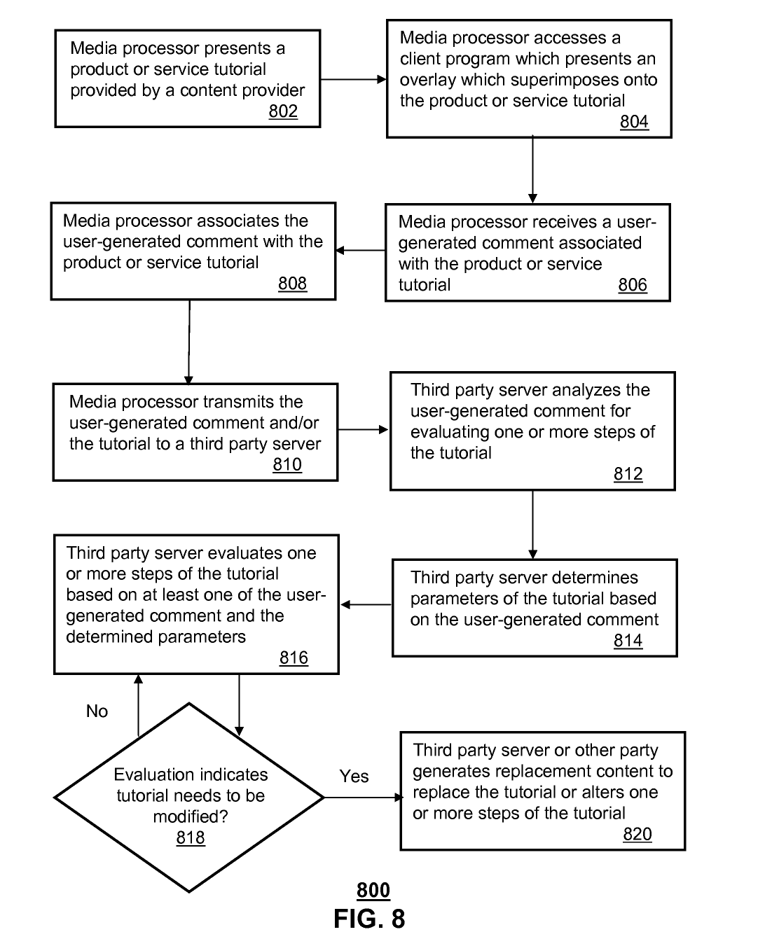

FIG. 8 depicts an illustrative method 800 for product tutorials that operates in portions of the communication systems of FIGS. 1-2 and FIG. 5. Method 800 can begin with step 802 in which a media processor can present media content provided by a content provider. The media processor can be a STB, personal computer, or other similar device and can be configured to operate in an iTV network, which can include IPTV, satellite television, and cable television. The media content can be video content, audio content, still image content, text content, and/or combinations thereof. In an embodiment, the media content can comprise a product and/or service tutorial, which can include one or more steps for utilizing the product or service. At step 804, the media processor can access a client program, which can present an overlay that superimposes onto the media content/tutorial presented at the media processor.

At step 806, the media processor can receive a user-generated comment and/or information associated with a user making the comment via the client program. The user-generated comment can indicate a user's thoughts on the product or service tutorial. For example, the comment can indicate that the user found the tutorial to be helpful, effective, confusing, or ineffective. Once the comment and/or information is received the media processor, the media processor can associate the comment and/or information with the media content/tutorial by utilizing the client program at step 808. At step 810, the media processor can transmit the user-generated comment, information, and/or the media content/tutorial to a server, such as a third party server.

At step 812, the server can analyze the user-generated comment and/or the information for evaluating one or more steps of the tutorial. At step 814, the server can determine parameters of the media content/tutorial based on the user-generated comment and/or the information associated with the user. As mentioned above, the parameters can include effectiveness parameters, demographic parameters, psychographic parameters, and other parameters. The server or a third party can proceed to evaluate one or more steps of the tutorial based on at least one of the user-generated comment and the determined parameters at step 816. At step 818, it can be determined if the evaluation indicates that the tutorial needs to be modified or entirely replaced.

If the evaluation indicates that the tutorial is effective as is, the server can continue to evaluate the tutorial as more comments are received at the server. If, however, the evaluation indicates that the tutorial is ineffective or needs to be modified, the server or a third party can generate replacement content that can be substituted for the tutorial or can alter one or more steps of the tutorial at step 820. The replacement content or an altered tutorial can then be transmitted to the media processor for presentation. In an embodiment, the server can receive a request for the user-generated comment and/or the media content/tutorial from a recipient media processor. Upon receiving the request, the server can transmit the user-generated comments and/or media content to the recipient media processor. The recipient media processor can then present the user-generated comments and/or the media content. Notably, the method 800 can further incorporate the operative functionality of the systems described above and the features described below.

Upon reviewing the aforementioned embodiments, it would be evident to an artisan with ordinary skill in the art that said embodiments can be modified, reduced, or enhanced without departing from the scope and spirit of the claims described below. For example, the server 506 can be configured to receive comments associated with the replacement media content and/or the altered content and can determine parameters based on the comments and/or information associated with users providing the comments. The comments and parameters associated with the replacement/altered media content can also be analyzed by the third parties. The third parties can then modify replacement/altered media content based on the comments and determined parameters.

In an embodiment, comments that describe other user's comments can also be analyzed by the server 506 and third party users for determining parameters and the effectiveness of the product or service tutorial. In another embodiment, the server 506 and other devices of the system 500 can be configured to filter content from the user-generated comments based on filtration parameters. The filtration parameters can include parameters for filtering obscenities, selected words, or other content. In yet another embodiment, the server 506 can be configured to assign a greater weight to comments coming from a particular demographic or psychographic and a lesser weight to others.

Other suitable modifications can be applied to the present disclosure without departing from the scope of the claims below. Accordingly, the reader is directed to the claims section for a fuller understanding of the breadth and scope of the present disclosure.

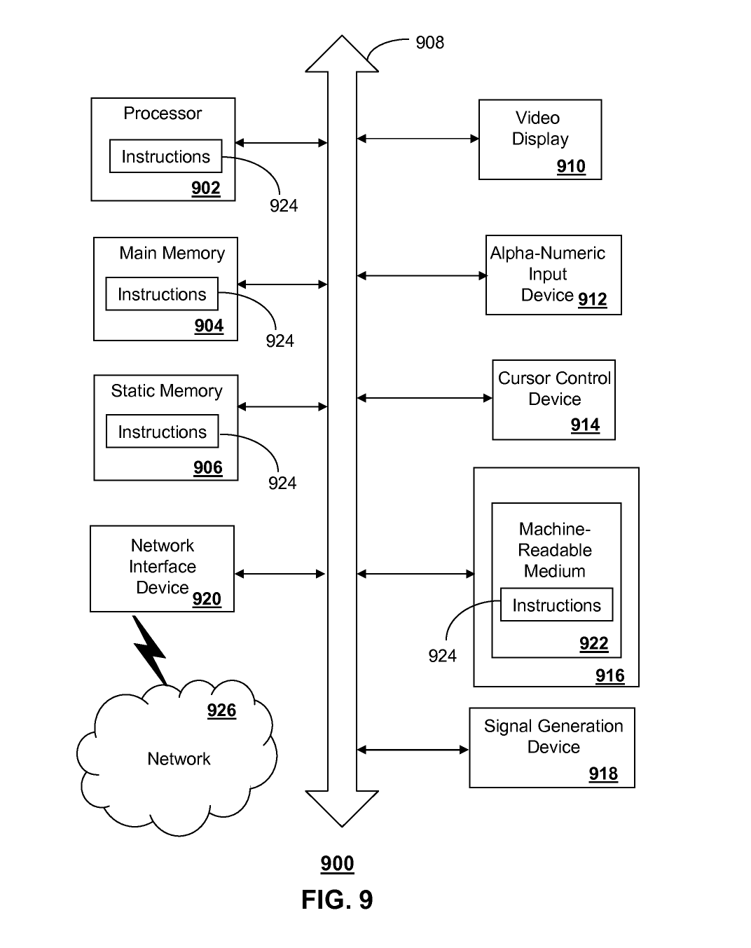

FIG. 9 depicts an exemplary diagrammatic representation of a machine in the form of a computer system 900 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910 (e.g., a liquid crystal display (LCD), a flat panel, a solid state display, or a cathode ray tube (CRT)). The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a machine-readable medium 922 on which is stored one or more sets of instructions (e.g., software 924) embodying any one or more of the methodologies or functions described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 924, or that which receives and executes instructions 924 from a propagated signal so that a device connected to a network environment 926 can send or receive voice, video or data, and to communicate over the network 926 using the instructions 924. The instructions 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A set-top-box (STB), comprising a controller to:
present media content supplied by a content provider operating in an interactive television (iTV) network, wherein the media content comprises a tutorial for one of a product and a service, the tutorial comprising steps for utilizing one of the product and the service;
access via a graphical user interface (GUI) a client program, wherein the client program presents an overlay that superimposes onto the media content;
receive a user-generated comment, wherein the user-generated comment is associated with the media content by the client program;
transmit the user-generated comment to a third party for analyzing the user-generated comment and determining parameters for evaluating at least one of the product and service tutorial, wherein replacement media content is generated by the third party based on the determined parameters.

2. The STB of claim 1, wherein the replacement media content is transmitted to the STB, and wherein the replacement media content comprises at least one of a replacement product and service tutorial.

3. The STB of claim 1, wherein one or more steps of the steps of the tutorial are adjusted based on at least one of the user-generated comment and the determined parameters.

4. The STB of claim 1, wherein the third party comprises a processor, and wherein at least one of the controller and the processor is adapted to filter the user-generated comment based on at least one filtration parameter.

5. The STB of claim 1, wherein the controller is adapted to receive a request from a recipient STB for at least one of the user-generated comment and the media content, and wherein the controller is further adapted to transmit at least one of the user-generated comment and the media content to the recipient STB.

6. The STB of claim 1, wherein the iTV network comprises internet protocol television.

7. The STB of claim 1, wherein the controller is adapted to receive information associated with a user associated with the user-generated comment, wherein the information comprises at least one of an identifier of the user, demographic information, an internet protocol address, and a location of the user.

8. The STB of claim 1, wherein the determined parameters comprise at least one of effectiveness parameters, psychographic parameters, and demographic parameters.

9. A method, comprising:
transmitting a client program to a media processor operating in an interactive television (iTV) network, wherein the client program comprises a graphical user interface (GUI) for presenting an overlay that superimposes onto media content presented at the media processor, and wherein the media content comprises a tutorial for one of a product and a service;
receiving a user-generated comment from the media processor via the client program, wherein the user-generated comment is associated with the media content by the client program;
analyzing the user-generated comment for evaluating one or more steps of the tutorial for one of the product and the service;
determining parameters of the media content based on the user-generated comment; and
evaluating the one or more steps of the tutorial based on the determined parameters.

10. The method of claim 9, comprising generating replacement media content based on the evaluation of the one or more steps of the tutorial and further comprising transmitting the replacement media content to the media processor.

11. The method of claim 9, comprising altering the one or more steps of the tutorial based on the evaluation of the one or more steps of the tutorial.

13. The method of claim 9, comprising receiving a request from a recipient media processor for at least one of the user-generated comment and the media content, and further comprising transmitting at least one of the user-generated comment and the media content to the recipient media processor.

14. The method of claim 13, comprising receiving a user-generated comment from the recipient media processor, and further comprising determining the parameters of the media content based on the user-generated comment from the recipient media processor.

15. The method of claim 14, comprising evaluating the one or more steps of the tutorial based on at least one of the user-generated comment from the recipient media processor and the determined parameters.

16. A computer-readable storage medium, comprising computer instructions to:
transmit a request to a computing device for media content and a first user-generated comment associated with the media content, wherein the media content comprises a tutorial for one of a product and a service;
receive the media content and the first user-generated comment from the computing device;
present the media content and the first user-generated comment;
receive a second-user generated comment, wherein the second user-generated comment is associated with at least one of the media content and the first user-generated comment; and
transmit the second user-generated comment to the computing device, wherein parameters for evaluating at least one of the product and service tutorial are determined by the computing device based on at least one of the first and second user-generated comments.

17. The computer-readable storage medium of claim 16, wherein the tutorial comprises one or more steps for utilizing one of the product and the service.

18. The computer-readable storage medium of claim 16, wherein replacement media content is generated by the computing device based on at least one of the first and second user-generated comments and the determined parameters.

19. The computer-readable storage medium of claim 16, wherein the determined parameters comprise at least one of effectiveness parameters, psychographic parameters, and demographic parameters.

20. The computer-readable storage medium of claim 17, wherein the one or more steps of the tutorial are altered by the computing device based on at least one of the first and second user-generated comments and the determined parameters.
